(19) United States
(12) Patent Application Publication
(10) Pub. No.: US 2005/0035092 A1
(43) Pub. Date: Feb. 17, 2005

(54) Method of making a hybrid housing and hybrid housing

(76) Inventors: Robert Eder, Moosburg (DE); Friedrich Schulte, Neufahrn (DE); Juergen Leib, Freising (DE)

Correspondence Address: STRIKER, STRIKER & STENBY, 103 East Neck Road, Huntington, NY, 11743, US

(21) Appl. No.: 10/881,909

(22) Filed: Jun. 30, 2004

(30) Foreign Application Priority Data
Jul. 2, 2003 (DE) 103 29 934.3

(51) Int. Cl. B23K 15/00

(52) U.S. Cl. 219/121.14

(57) ABSTRACT

The hybrid housing includes a base housing and one or more separately made functional components joined in the base housing by electron beam welding to provide a hermetically sealed hybrid housing e.g. for use under water or in aircraft or spacecraft. The separately made functional components can included e.g. a KOVAR-glass feed-through device and/or a copper or molybdenum metal block for heat dissipation. The base housing can be made of aluminum, an aluminum alloy, stainless steel or VA steel.

### BACKGROUND OF THE INVENTION

1. Field of the Invention

The present invention relates to a method of making a hybrid housing and to a hybrid housing.

2. Related Art

A hybrid housing is a housing for a hybrid circuit. Hybrid circuits are electronic modules, which are built into a larger circuit or a circuit board and perform special functions of the entire assembly. They comprise a supporting substrate, on which conductor strips and components are mounted. Generally thin film technology is employed. A metal layer is sputtered on the substrate to make conductor strips and ohmic resistors. In subsequent manufacturing steps additional active and passive components and additional connections are completed. According to the particular application ceramic material, glass, quartz and in a few cases sapphire are used as the substrate material.

Modern electronics requires a high degree of miniaturization. In order to fulfill the requirements for higher packing, power density and function density, components without housings, which are mounted directly on the substrate, are predominantly used in hybrid manufacture. Bonding wires connect the semiconductor components with the conductor strips. A hybrid housing protects sensitive semiconductor components. The housing is preferably metal. The metal housing has the advantage of high thermal conductivity, great many forms and that it can be sealed in a gas-tight manner. Besides metal housings ceramic housings can be used, for example for high voltage applications.

Hybrid housings often have KOVAR-glass feed-through devices. KOVAR® is a nickel-iron-cobalt alloy comprising 29 percent by weight nickel, 18 percent by weight cobalt and an iron residue. Glass-metal feed-through devices are vacuum-tight fusions of glass and metal for insulated feed-through of electric conductors into hermetically enclosed housings. The melted glass serves as an insulator. Mechanical stresses invariably arise during fusion because of differences in thermal expansion coefficients of glass and metal. Since KOVAR® has only a very slightly higher thermal expansion coefficient than glass, it is a preferred alloy for glass-metal feed-through devices.

Already hybrid housings are on the market, which are made from a solid KOVAR® block or blank by milling or machining. The glass feed-through device is already melted into or subsequently melted into the KOVAR® block or blank. This leads to very high manufacturing costs, since the starting material is very expensive, much material is lost during milling or machining and much time is consumed for mechanical work. Usually 90% material removal must be taken into consideration. Moreover faulty fusion of the glass feed-through device leads to disposal of the entire housing.

### SUMMARY OF THE INVENTION

It is an object of the present invention to provide a method of making a hybrid housing that has reduced manufacturing costs.

It is another object of the present method to provide a hybrid housing having increased capabilities.

The method of making the hybrid housing according to the invention comprises joining or assembling a base housing and at least one separately made functional component with each other by electron beam welding, wherein a KOVAR-glass feed through is used as at least one of the functional components.

The hybrid housing according to the invention comprises a base housing and at least one electronically welded KOVAR-glass feed-through device and/or at least one electronically welded metal block for heat dissipation as functional components, which is or are joined or assembled with the base housing by electronic welding.

Until now the entire hybrid housing was milled from expensive KOVAR®, equipped with a glass-feed-through device and sealed in a continuous or feed-through furnace. Now the functional components are made separately and then assembled in the finished and similarly tested base housing by electron beam welding after a quality control. Already waste costs are considerably reduced because of this change.

Since the base housing is built up from individual parts, such as a base, walls, etc, by welding the manufacturing costs can be further reduced.

The term “base housing” within the context of the present invention means a housing without added functional parts or components, such as the feed-through device.

Electron beam welding has the smallest specific heating, the smallest weld seam and the smallest distortion of all fusion welding methods. The electron beam functioning as heat source is controllable in regard to impact location and power and is controllable in an almost inertia-less manner. Almost all commercially obtainable steel, aluminum, cooper and nickel materials can be welded as well as special metals, such as titanium, zirconium and molybdenum including numerous mixed compounds. Electron beam welding permits very high processing speed in comparison to other fusion welding methods. Fusion welding speeds of up to 1 m/s are achieved with power densities of up to 10⁷ W/cm². Since the electron beam is very directional, weld seams that are complex or located in inaccessible locations can be made. The weld seam preparation is comparatively easy, since the individual parts need only be mounted in position with as little gap as possible. In as much as electron beam welding is an all-round useful welding method manufacturing costs can be especially reduced in mass production.

A KOVAR-glass feed-through device is used as at least part of the at least one functional part or component. Since the base housing and the KOVAR® are electron beam welded, a hermetic seal is obtained. This is important in as much as the hybrid housings are often subsequently coated. In that case the coating material would otherwise enter the weld gap by capillary action. This could occur again during later use of the hybrid housing and interfere with the electronics in the hybrid housing. Furthermore the electron beam welding hermetically seals the weld seam, so that this hybrid housing could be used under water. For example, it could be used for an amplifier to be installed under water.

In an additional preferred embodiment a metal block is used as a functional part for heat conduction. This sort of metal block serves especially for improved heat dissipation during temperature spikes or peaks. Preferably it comprises cooper or molybdenum or another material with high heat conductivity. Up to now this sort of block was soldered in place. This has several disadvantages. First the solder joint obtained cannot resist high temperatures, so that the connection can be broken or unsealed. Furthermore a third material is required as solder for the soldering, which makes the method more expensive. In contrast, the weld seam made by electron beam welding produces a connection, which withstands high temperature and is hermetically well sealed. Also it has a higher mechanical strength.

Advantageously the base housing is made from a non-magnetic material. This has the advantage that interfering fields, which act negatively on the electronics in the housing, are minimized in contrast to KOVAR® housings. Preferably aluminum, steel or aluminum alloys, e.g. stainless steel, especially VA-steel are used. Aluminum and its alloys have the advantage of reduced density in comparison to KOVAR®. They are thus especially suitable for use in aircraft and spacecraft. Stainless steel in contrast is easily worked and is less expensive as a starting material than KOVAR®), so that manufacturing costs are further reduced by use of stainless steel for the base housing.

The metal blocks for heat transfer are preferably made from a material with a high specific thermal conductivity, e.g. copper or molybdenum. In order to increase efficient heat dissipation, the metal block preferably has ducts or channels for a cooling medium.

### BRIEF DESCRIPTION OF THE DRAWING

The objects, features and advantages of the invention will now be described in more detail with the aid of the following description of the preferred embodiments, with reference to the accompanying figures in which:

FIG. 1a is an exploded perspective view of a first embodiment of the hybrid housing according to the invention;

FIG. 1b is an interior perspective view of the hybrid housing shown in FIG. 1a;

FIG. 1c is a plane view of the hybrid housing shown in FIG. 1a;

FIG. 1d is a cross-sectional view of the hybrid housing and cooling block of FIG. 1a taken along the section line A-A of FIG. 1c;

FIG. 1e is a side view of a hybrid housing with a cooling block as shown in FIG. 1a;

FIG. 2a is an outside perspective view of a hybrid housing with a KOVAR-glass feed-through device according to a second embodiment of the invention;

FIG. 2b is an interior perspective view of the hybrid housing of FIG. 2a; and

FIG. 3 is an exploded perspective view of a third embodiment of a hybrid housing according to the invention with a cooling block and KOVAR-glass feed through.

### DESCRIPTION OF THE PREFERRED EMBODIMENTS

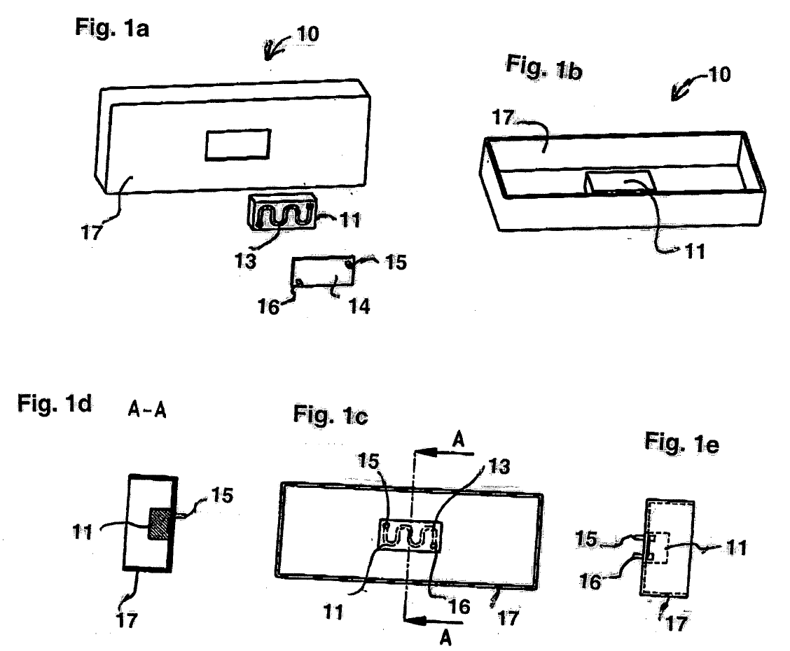

A hybrid housing 10 is shown in FIG. 1a in an exploded perspective view. The hybrid housing 10 comprises a base housing 17 made from aluminum and a copper block 11, which is assembled or joined with the base housing 17 by electron beam welding and serves for heat dissipation at temperature peaks. For improved heat dissipation the cooper block 11 has a cooling duct 13 for a cooling medium or fluid. The copper block 11 with cooling ducts 1 is covered by the cover plate 14. The cover plate 14 has two connectors 15, 16 for the cooling fluid. Because of the light-weight base housing 17 made from aluminum and the electronic weld seam between the base housing 17 and the copper cooling block 11, which is resistant to high temperatures and hermetically sealed, the hybrid housing 10 is especially suitable for use in aircraft and spacecraft.

In FIG. 1b the interior of the hybrid housing 10 is shown in perspective, so that the base housing 17 and the copper block 11 can be seen. The structure of this embodiment of the hybrid housing 10 is also clearly illustrated in FIGS. 1c to 1e. From these figures it is apparent that the welded copper block 11 protrudes into the base housing 17 so that a maximum amount of heat can be removed from the housing interior and transported to the outside.

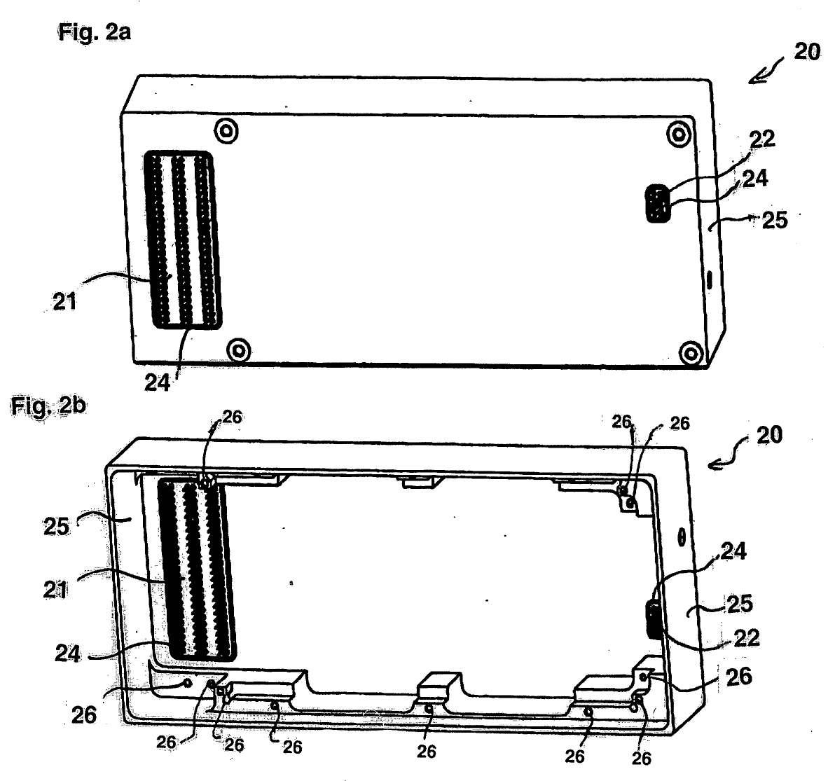

In FIG. 2a a hybrid housing for an amplifier for an underwater cable is shown. The hybrid housing 20 has a base body made of stainless steel as essential part and a large KOVAR-glass feed-through device 21 and a small KOVAR-glass feed-through device 22, which are connected with the base housing 25 by means of weld seams 24. With the help of electron beam welding a hermetically sealed weld seam 24 between KOVAR®) and stainless steel is provided, which withstands the pressure during use under water.

FIG. 2b is an interior perspective view of the hybrid housing 20 shown in FIG. 2a. The base housing 25 has a plurality of screw threads 26 for attachment of the housing to a supporting substrate for the hybrid circuit.

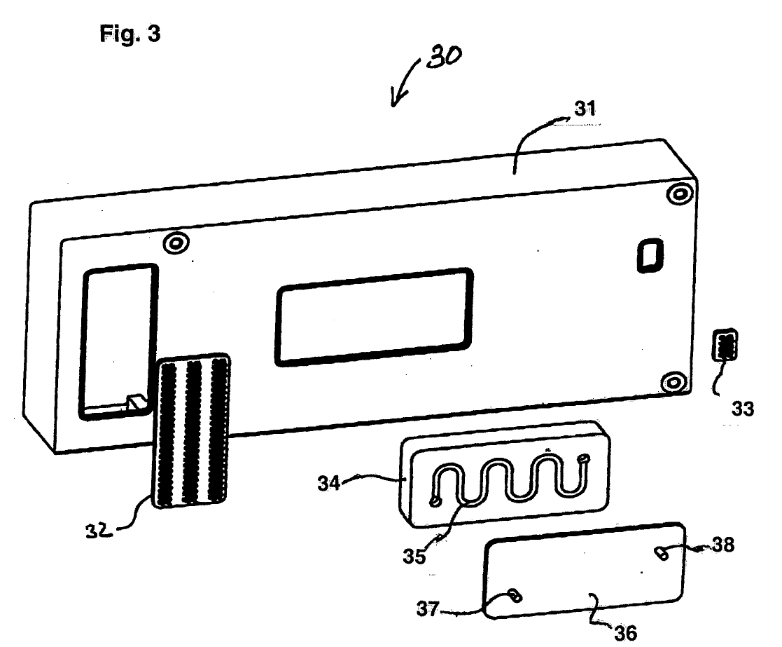

In FIG. 3 the hybrid housing 30 is shown, which can be used as a processor housing. It has a base housing 31 made from VA steel and a large KOVAR-glass feed-through device 32 and a small KOVAR-glass feed-through device 33, as well as a copper block 34. These three functional components are connected with the base housing 31 made of VA steel by electron beam welds. The KOVAR-glass feed-through devices 32,33 are for electronic input and output of peripheral devices, which are connected to the processor in the housing interior. Because of the high component density in a processor large amounts of heat are generated within the hybrid housing 30. In order to be able to conduct away the heat, the copper block 34 is required. In order to be able to increase its power output, it has a duct or channel 35 for a cooling medium. A cover plate 36, which has two connectors 37,38, for the cooling medium, closes the copper block 34 with the duct 35.

The disclosure in German Patent Application 103 29 934.3-33 of Jul. 2, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a method of making a hybrid housing and a hybrid housing, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method of making a hybrid housing, said method comprising joining or assembling a base housing and at least one separately made functional component with each other by electron beam welding;
wherein said at least one separately made functional component includes a KOVAR-glass feed-through device.

2. The method as defined in claim 1, wherein said at least one separately made functional component includes a metal block for heat dissipation.

3. The method as defined in claim 2, wherein said metal block is a copper or molybdenum block.

4. The method as defined in claim 2, wherein said metal block is provided with a duct or channel for a cooling medium and extends into an interior of the base housing.

5. The method as defined in claim 1, wherein said base housing comprises a non-magnetic metal.

6. The method as defined in claim 5, wherein said non-magnetic metal is aluminum, an aluminum alloy, stainless steel or VA steel.

7. A hybrid housing comprising a base housing and at least one KOVAR-glass feed-through device acting as a functional component, which is joined to or assembled with said base housing by an electron beam weld seam.

8. The hybrid housing as defined in claim 7, further comprising a metal block for heat dissipation acting as another functional component, which is joined to or assembled with said base housing by another electron beam weld seam.

9. The hybrid housing as defined in claim 8, wherein said metal block extends into an interior of said base housing and includes a duct or channel for a cooling medium.

10. The hybrid housing as defined in claim 7, wherein said base housing comprises a non-magnetic metal selected from the group consisting of aluminum, aluminum alloys, stainless steel and VA steel.

11. A hybrid housing comprising a base housing and a metal block acting as a functional component for heat dissipation, wherein said metal block is joined to or assembled with said base housing by an electron beam weld seam.

12. The hybrid housing as defined in claim 8 or 11, wherein said metal block consists of molybdenum or copper metal.

13. The hybrid housing as defined in claim 11, wherein said metal block protrudes into an interior of said base housing.

14. The hybrid housing as defined in claim 11 or 13, wherein said metal block has a duct for a cooling medium.
